(19) United States
(12) Patent Application Publication
(10) Pub. No.: US 2014/0143860 A1
(43) Pub. Date: May 22, 2014

(54) TWO TIER VERIFICATION SYSTEM AND METHOD

(71) Applicant: Dotan DRUCKMAN, Kfar Saba (IL)

(72) Inventor: Dotan DRUCKMAN, Kfar Saba (IL)

(21) Appl. No.: 13/680,924

(22) Filed: Nov. 19, 2012

(51) Int. Cl. G06F 21/36

(52) U.S. Cl. CPC G06F 21/36
USPC 726/19

(57) ABSTRACT

A system method and device for multi-tier authentication, the method including obtaining at least one of a series of images of a registered personal item using an image sensor of a portable computing device and verifying that the registered personal item appears in a pre-designated zone within each image of said at least one of a series of images, such that the personal item appearance in the pre-designated zone follows a predetermined pattern.

### FIELD OF THE INVENTION

The present invention relates to verification. Specifically, the present invention relates to a two tier verification system and method.

### BACKGROUND OF THE INVENTION

Two-factor or two tier authentication is an authentication protocol system which requires the presentation of two or more of the three standard independent authentication factors. These factors are (i) a knowledge factor; i.e., something the user knows—but something that someone who may be attempting to enter illicitly should not know. (ii) A possession factor; e.g. something the user has but something that a user who is attempting to enter illicitly should not have. And (iii) and an inherence factor; e.g., something the user is but typically is not something that the user who is attempting to enter illicitly is.

Two-tier authentication may be commonly found in electronic computer authentication, and or other daily identification uses. For example, an automated teller machine (ATM) associated with a bank may use a multi-tier authentication system wherein the person trying to extract money from the ATM is authenticated using at least two independent factors.

In general, two-factor or two tier authentication may serve to decrease the likelihood that the person attempting to access a device, or system or perform any other authentication-requiring action protected by the authentication system, and presenting false evidence of its identity, can gain access to the system, device or something else protected by the authentication system.

Typically there is a relation between the number of factors in the authentication procedure and the likelihood that the individual or system providing the factors to be authenticated is the person or system that they claim to be. In addition to the number of factors presented in the authentication system, the authentication system may be made more robust by choosing factors that are less likely to be falsified and/or that are more representative of the individual or system trying to be authenticated.

Guidelines promulgated by the Homeland Security Presidential Directive 12 (HSPD-12) and U.S. Federal Financial Institutions Examination Council suggest that true multifactor authentication requires the use of identification information from two or more of the three categories of factors described above.

### SUMMARY OF THE INVENTION

It is therefore an object of the present invention to provide a method for multi-tier authentication, the method including, obtaining at least one of a series of images of a registered personal item using an image sensor of a portable computing device and verifying that the registered personal item appears in a pre-designated zone within each image of said at least one of a series of images, such that the personal item appearance in the pre-designated zone follows a predetermined pattern.

Furthermore, in accordance with some embodiments of the present invention, said pre-designated zones are shapes superimposed on a screen of a portable computing device.

Furthermore, in accordance with some embodiments of the present invention, said multi-tier authentication further includes verifying a second registered personal item.

Furthermore, in accordance with some embodiments of the present invention, said portable computing device is a smartphone.

Furthermore, in accordance with some embodiments of the present invention, said registered personal item is a fingerprint.

Furthermore, in accordance with some embodiments of the present invention, a remote device is configured to verify that the registered personal item appears in a pre-designated zone within each image of said at least one of a series of images, such that the personal item appearance in the pre-designated zone follows a predetermined pattern.

Furthermore, in accordance with some embodiments of the present invention, the method includes causing a performance of an authentication-requiring action, after verifying that the registered personal item appears in the pre-designated zone within each image of said at least one of a series of images, such that the personal item appearance in the pre-designated zones follows the predetermined pattern.

Furthermore, in accordance with some embodiments of the present invention, said authentication-requiring action is selected from the group consisting of opening, unlocking and manipulating devices remotely.

Furthermore, in accordance with some embodiments of the present invention, said authentication-requiring action may be performed on a device, the device selected from the group consisting of a garage door, a car door, a window, a gate, a safe, a video game, accouterments of a garage door, a car door, a window, or a gate, a television, an entertainment unit, a computer, a recording device, a computing system, a smartphone, a weapon, a portable locking device, a bicycle lock, a drawer, a secret passage, a secret safe, a military device, a remote controlled car, a remote controlled device, secure room, a secure facility, a hotel room, a drone, a locker, an encrypted file, a virtual private network, a network access, a locker at a pickup location, a strongbox, and a vault.

There is further provided, in accordance with some embodiments of the present invention, a system for multi-tier authentication, the system including a portable computing device having an image sensor to obtain at least one of a series of images of a registered personal item, and a processing unit to verify that the registered personal item appears in a pre-designated zone within each image of said at least one of a series of images, such that the personal item appearance in the pre-designated zones follows a predetermined pattern.

Furthermore, in accordance with some embodiments of the present invention, the system includes a communication unit to communicate a signal to perform an authentication-requiring action to a device, after verifying that the registered personal item appears in the pre-designated zone within each image of said at least one of a series of images, such that the personal item appearance in the pre-designated zones follows the predetermined pattern.

Furthermore, in accordance with some embodiments of the present invention, the system includes a device to perform an authentication-requiring action.

Furthermore, in accordance with some embodiments of the present invention, wherein said device to perform the authentication-requiring action is selected from the group consisting of a garage door, a car door, a window, a gate, a safe, a video game, accouterments of a garage door, a car door, a window, or a gate, a television, an entertainment unit, a computer, a recording device, a computing system, a smartphone, a weapon, a portable locking device, a bicycle lock, a drawer, a secret passage, a secret safe, a military device, a remote controlled car, a remote controlled device, secure room, a secure facility, a hotel room, a drone, a locker, an encrypted file, a virtual private network, a network access, a locker at a pickup location, a strongbox, and a vault.

Furthermore, in accordance with some embodiments of the present invention, wherein said portable computing device is a smartphone.

Furthermore, in accordance with some embodiments of the present invention, wherein said processing unit is in a remote location.

Furthermore, in accordance with some embodiments of the present invention, wherein said registered personal item is a fingerprint.

There is further provided, in accordance with some embodiments of the present invention, a non-transitory computer readable medium for multi-tier authentication, comprising instructions, which when executed cause one or a plurality of processors to obtain at least one of a series of images of a registered personal item using an image sensor of a portable computing device and verify that the registered personal item appears in a pre-designated zone within each image of said at least one of a series of images, such that the personal item appearance in the pre-designated zone follows a predetermined pattern.

Furthermore, in accordance with some embodiments of the present invention, wherein said instructions are configured to be executed on a smartphone.

Furthermore, in accordance with some embodiments of the present invention, wherein some of said instructions are configured to be executed locally and some of the instructions are configured to be executed remotely.

Furthermore, in accordance with some embodiments of the present invention, further including instructions, which when executed cause one or a plurality of processors to perform an authentication-requiring action, after verifying that the registered personal item appears in the pre-designated zone within each image of said at least one of a series of images, such that the personal item appearance in the pre-designated zones follows the predetermined pattern.

### BRIEF DESCRIPTION OF THE DRAWINGS

In order to better understand the present invention, and appreciate its practical applications, the following Figures are provided and referenced hereafter. It should be noted that the Figures are given as embodiments only and in no way limit the scope of the invention. Like components are denoted by like reference numerals.

FIG. 1 is a schematic illustration of a portable computing device configured to employ multi-tier authentication according to an embodiment of the present invention;

FIG. 2 is a schematic illustration of a method of using a two tier verification system on a portable computing device according to an embodiment of the present invention; and,

FIG. 3 is a schematic illustration of a method for using a two tier verification system according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the embodiments disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

A portable computing device may be configured to facilitate, initiate, and/or perform an authentication-requiring action. An authentication-requiring action may include an action conducted by a device in response to a signal from the portable computing device, wherein the signal is generated in response to the completion and verification of correct completion, in some embodiments of the invention, by a user, of an authentication protocol.

In some embodiments of the invention, a device may be configured to respond to one or a plurality of signal requesting that an authentication-requiring action be performed. The signal may be a key.

A system may be configured such that a first device may be configured to respond to a particular predefined signal from a portable computing device or from a plurality of portable computing devices, to perform and authentication-requiring action. In some embodiments of the invention, a handshake, e.g., an automated negotiation process between a first and second device that dynamically sets parameters of a communications channel established between the devices may need to occur.

In some embodiments a user may need to configure the portable computing device to interface with the first device to complete the authentication-requiring action. In some embodiments of the invention this may be preconfigured.

A user may be prompted to configure an interface, in some embodiments of the invention, by the device configured to perform an authentication-requiring action, in some examples, by a portable computing device, when the user first acquires a device configured to perform an authentication-requiring action.

A user may be prompted by the portable computing device to configure and/or design a authentication protocol, wherein, in response to a later correct fulfillment of the authentication protocol, the portable computing device, or a component therein, will send one or a plurality of signals, directly and/or indirectly, requesting that an authentication-requiring action be performed.

The user may set up an authentication protocol with hardware and/or software associated with a method of opening, unlocking or manipulating devices remotely. In some embodiments, the user may purchase and/or receive a preset authentication protocol associated with hardware and/or software, the hardware and/or software associated with a method of opening, unlocking or manipulating devices remotely.

The signal may be sent via a wired or wireless connection. The signal may be sent via a computer network. The signal may be sent via a communications network.

In some embodiments of the invention, configuring and/or designing an authentication protocol may include identifying a personal item and registering that personal item with the personal computing device or a device or software associated with the portable computing device, e.g., a program running on a remote server.

Registration may include, for example, identifying and recording unique identifiers for a personal item for a first tier in an authentication system, e.g., specific swirls and loops on a fingerprint. Registration may also include setting parameters as to the nature of the required match of the recalled registered item and the item presented to the personal computing device as the registered item to be used in completing the authentication protocol. A match between a registered fingerprint and a fingerprint as observed by the portable computing device may not need to be exact, taking into account the quality of a camera on the portable computing device.

An authentication protocol may be multi-tiered. A second tier in a multi-tier authentication protocol may include completing a predefined pattern, or locating and identifying one or a plurality of predefined or pre-designated zones. The identification of predefined or pre-designated zones may be done by having the personal item appear on the screen of a portable computing device within the predefined or pre-designated zones. A user may configure the predefined pattern or the location of a pre-designated zone prior to using the authentication protocol.

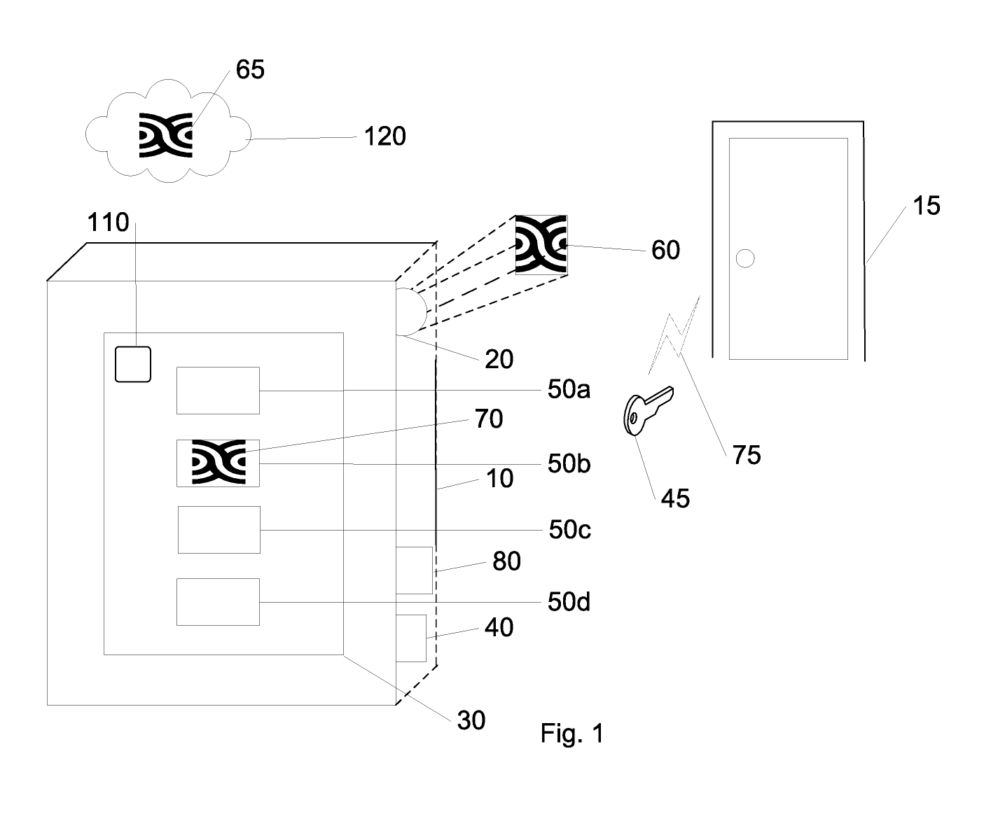

FIG. 1 is a schematic illustration of a portable computing device configured to employ multi-tier authentication protocols according to an embodiment of the present invention.

In some embodiments of the invention, a portable computing device may include software configured to run on a portable computing device 10. The software may run remotely on another computing device, or in a cloud or a remote server. The portable computing device may have one or a plurality of image sensors, e.g., a camera 20. In some embodiments, portable computing device 10 may have two sensors, including, for example, a front facing and a rear facing camera.

Portable computing device 10 includes a screen 30 for displaying data and/or information. Screen 30 may allow for a user to interact with portable computing device 10 through touch or other screen based interfaces. Screen 30 may be an interface for inputting information or other data for an authentication protocol.

Portable computing device 10 may have one or a plurality of inputs, including a touch screen, e.g., screen 30 and/or additional buttons, the interfaces may be directly coupled to portable computing device 10 or may peripheral to portable computing device 10.

Portable computing device may be a smartphone. In some embodiments, portable computing device 10 may be a dedicated device for employing an authentication protocol, for example a remote control device. Portable computing device 10 may be configured to communicate with other devices. The communication with other devices may be accomplished via a wired or wireless connection. In some embodiments of the invention, portable computing device may be configured to communicate with other devices via, Bluetooth, infrared, cellular or other wireless technologies.

Portable computing device 10 may be configured to communicate with other devices to perform one or a plurality of authentication-requiring actions, including, the facilitating of access, unlocking, opening or otherwise operating those devices. A processing unit 40 may run one or a plurality of software programs on portable computing device 10. The one or a plurality of software program may be configured to, in response to an input from a user, communicate with other devices and unlock, open or otherwise operate those devices. The one or a plurality of software program may be an application on an iOS device or an application on a windows phone device or an application on a Google Android device.

In some embodiments of the invention, portable computing device 10 may be configured to communicate with one or a plurality of other devices and facilitate access, unlock, open or otherwise operate those devices after a code, sequence or other input is inputted into portable computing device 10, the input successfully employed to correctly complete an authentication protocol.

A user may capture an image of one or a plurality of personal items 60, e.g., a fingerprint or a different personal item. The personal item may be registered. In some embodiments of the invention, the portable computing device may communicate with a remote system to identify an unregistered personal item. The user may capture an image of at least two distinct personal items. The two distinct personal items may be employed for use in one or a plurality of authentication systems.

A fingerprint or another personal item may be captured by camera 20 associated with portable computing device 10 or another sensor, e.g., a fingerprint sensor. When an image of a fingerprint is captured by a camera, the image of the fingerprint, as employed by the portable computing device, may be static and reflect only a first or subsequent image taken by camera 20. In some embodiments, the image of the fingerprint may be a compilation of multiple images or a series of images. An image of a fingerprint as captured by camera 20 may be the result of a compilation of images and/or captured data, providing a comprehensive and/or detailed view of the fingerprint. The captured image of a fingerprint may be updated once or a multiple of times by the camera while being used in an authentication system, the system using employing an authentication protocol. In some embodiments the image of the fingerprint is updated in real-time, e.g., a real-time video.

The captured fingerprint, and/or other personal item may be compared by software running locally on portable computing device 10, or remotely with a known set of fingerprints, e.g., a registered fingerprint and/or registered personal item 65. In some embodiments, image comparison software, and/or other software are employed to make the comparison.

One or a plurality of images or video of personal item 60 may be used by portable computing device 10, wherein the user may be required to align the captured video and/or image of personal item 60, personal item 60 matching registered personal item 65, in one or a plurality of pre-designated zones on screen 30. In some embodiments of the invention the user may align the captured image in a pre-designated zone on screen 30 wherein the screen depicts an overlay of an image not consistent with the image in the camera's 20 field of view. In some embodiments of the invention the user may align the captured image within pre-designated zones within a predefined order, sequence or pattern, e.g., within one or a plurality of shapes 50, wherein the one or a plurality of shapes 50 may be overlaid on screen 30 or overlaid elsewhere, for example on a second screen, or other surface on portable computing device 10, or on a device coupled physically or wirelessly to portable computing device 10.

In some embodiments, personal item 60 may embody two tiers of authentication, e.g., “something the user has” and “something the user is”. In some embodiments, personal item 60 may embody a single tier of authentication, e.g., “something the user has” or “something the user is”.

In some embodiments of the invention, a user may be presented with a series of shapes 50 on screen 30. There may be one or a plurality of shapes, e.g., shape 50a, shape 50b, shape 50c and shape 50d. There may be fewer or a greater number of shapes 50.

The user may be prompted to capture an image, video or other visual input and/or audio/visual input with camera 20 or other sensor, including in some embodiments, a microphone. The user may be prompted to capture a plurality of images, video or other visual inputs and/or audio/visual inputs in a particular order or a specific order.

The user may be prompted to capture a plurality of images of personal item 60 in at least one of shapes 50a, 50b, 50c, and/or 50d in a particular order, sequence and/or pattern, e.g., captured image 70 in shape 50b. The user may capture the image of personal item 60 in a least one of the shapes 50 by manipulating the camera and/or the personal item, such that, for example the location of personal item 60 in camera's 20 field of view aligns personal item 60 within the location of shape 50 on screen 30, or in a pre-designated zone on screen 30.

The order, sequence and/or pattern may be wholly sequential or may include temporal and other pattern aspects. For example, the order, sequence, and/or pattern may include a sequence inputted in a specified amount of time, a specific temporal period, or the amount of time, between inputs may be regulated. The order, sequence and/or pattern may include a sequence of images inputted at a specific time on a clock, e.g., at the top of a minute.

A successful completion of the authentication protocol may include a number of actions by the user, whereby the result of the user's actions is the viewing of personal item 60, wherein the captured image 70 representing personal item 60 matches the data representing registered personal item 60, in at least one pre-designated zone. In some embodiments, in at least one pre-designated zone on screen 30 in a predefined pattern.

In some embodiments, the user may be required to both input an order, sequence, and/or pattern, the order, sequence, and/or pattern including a sequence inputted in a specified amount of time, or the amount of time, between inputs may be regulated and a voice recording, the voice recording may be authenticated by portable computing device 10.

In some embodiments of the invention, a front facing sensor and/or a rear facing sensor or a plurality of front facing sensors, and/or a plurality of rear facing sensors, and or a front facing camera and/or a rear facing camera, may be used simultaneously to both capture an order, sequence, and/or pattern of personal item 60 and to capture an image that can be employed for facial recognition, an iris scan or another form of identification or another type of personal item.

In some embodiments, the captured image from one of the sensors or cameras may capture an order, sequence, and/or pattern of personal item 60, and a second sensor or camera may capture an order, sequence, and/or pattern of facial expressions, hand waving, finger pointing, or other movements or a different persona item of the user.

Portable computing device 10 may include software, e.g., instructions on a non-transitory computer readable medium. The software may be configured to determine the authentic nature of personal item 60, e.g., that captured image matches, or matches to a pre-defined threshold registered personal item 65. Data related to registered personal item 65 may be kept, maintained held or otherwise retained (henceforth, maintained) as an encrypted or unencrypted file on portable computing device 10. Data related to registered personal item 65 may be maintained as an unencrypted or encrypted file in the cloud 120, a remote server, or other location.

Portable computing device 10 may include software for providing clear macro images of one or a plurality of personal items 60, e.g., providing a focused picture of a fingerprint including unique and/or identifying information. In some embodiments software may be included to optimize the image of personal item 60 for the application described herein, e.g., software may be provided that may enhance the imaging capability of camera 20 or other sensors associated with portable computing device 10.

An electronic key 75 incorporating a command for a device to perform an authentication-requiring action, e.g., a signal incorporating a digital certification, authentication code and/or other method for keyless opening, unlocking or manipulating devices remotely, (herein referred to as a key). Key 75 may be employed to facilitate access, unlock, open, manipulate, or otherwise interact with another device, e.g., for use in an authentication-requiring action, for example, by sending a signal 45, e.g., a coded, encrypted or other type of signal to a door 5 on or within a building.

Key 75, signal 45 and other communications may be sent using a communication unit 80. The communication unit may be configured to communicate a signal to perform an authentication-requiring action to a device, after verifying that the registered personal item appears in the pre-designated zone within each image of said at least one of a series of images, such that the personal item appearance in the pre-designated zones follows the predetermined pattern. The performance of an authentication-requiring action may be confirmed by communication between the device performing the authentication-requiring action and portable computing device 10.

Signal 45 may also be sent to other devices to be accessed, unlocked, opened, manipulated, or otherwise interacted with, a door 15, or others items including, a garage door, a car door, a window, a gate, a safe, a video game, accouterments of a garage door, a car door, a window, or a gate, a television, an entertainment unit, a computer, a recording device, a computing system, a smartphone, a weapon, a portable locking device, a bicycle lock, a drawer, a secret passage, a secret safe, a military device, a remote controlled car, a remote controlled device, secure room, a secure facility, a hotel room, a drone, a locker, an encrypted file, a virtual private network, network access, a locker at a pickup location, a strongbox, a vault, or other items that may be locked or manipulated.

Signal 45 may be sent directly to the device configured to do the authentication-requiring action. Signal 45 may be sent to a network, e.g., a telecommunications network, a computer network, or one or a plurality of other remote locations or network before the signal is received by the device configured to the authentication-requiring action.

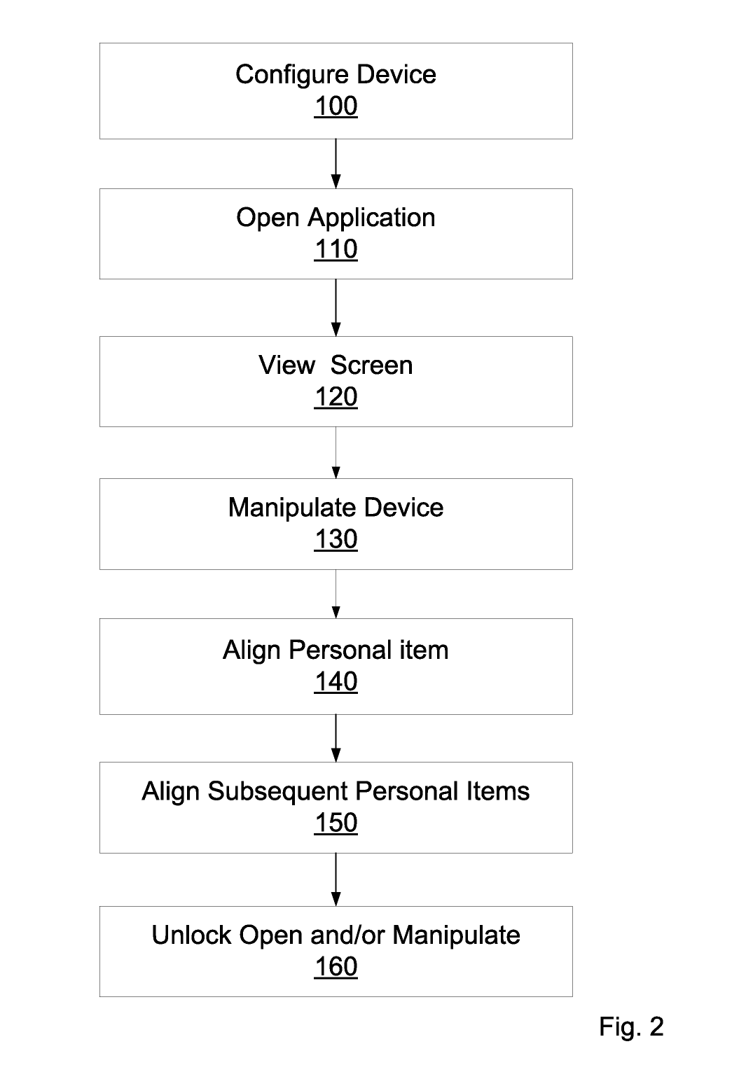

FIG. 2 is a schematic illustration of a method of using a two tier verification system on a portable computing device according to an embodiment of the present invention.

References are made herein to systems, devices, units and components that are also described, for example, above, with reference to FIG. 1.

In some embodiments of the invention, a portable computing device 10, e.g., a smartphone and/or other computing device may be configured to provide an electronic key 75, e.g., a digital certification, authentication code and/or other method communicating with a device, for example, to instruct the device to commence or complete an authentication-requiring action. An authentication-requiring action may include keyless opening, unlocking or manipulating devices remotely for use in at least this portion of a method depicted as box 100. In some embodiments of the invention, the authentication-requiring action may be performed by the portable computing device, e.g., wherein the authentication-requiring action is unlocking the smartphone or accessing an encrypted area within the smartphone.

Key 75, in some embodiments of the invention, may include a signal sent to another device. The key may be sent via wired or wireless signal. The key may be encrypted on unencrypted. The key may be sent directly or indirectly via at least one intermediary network. The key may be predesigned or may be a rolling or hopping code, e.g., a 40 bit rolling code, based on, for example a random or pseudorandom number generator. The key may be a string of numbers, letters and/or symbols.

The key may be an encrypted string and or code stored on portable computing device 10, or on a remote device that may be in communication with portable computing device, for example, stored on the cloud and accessed by the portable computing device, and/or used by the portable computing device to signal the device designated to complete an authentication-requiring action, when the user successfully completes the multi-tier authentication.

The ability to employ the electronic key may be made available to the user when the user successfully employs the portable computing device to capture one or a series of images of a personal item, the captured images of the personal item matching a registered personal item to be used within an authentication sequence. In some embodiments, the image of the registered personal item may be real-time images of fingerprints and/or of other personal items. In some embodiments, portable computing device may employ one or a plurality of processing units, the processing units may be configured to determine whether the image of the personal item is a real-time image of the personal item or an image of an image of the personal item, or an image of a representation of the personal item or an image of a non-authentic personal item. In some embodiments only an authentic image of an actual personal item 60, the image taken in real-time by a camera associated with personal computing device can be used to access the electronic key.

In some embodiments of the invention, a user may be within the vicinity of the device, or item that they want unlocked, opened or manipulated. In some embodiments, the user may need to be near enough so that a signal, e.g., a Bluetooth signal, from the portable computing device can reach the device, or item that is to be unlocked, opened or manipulated.

In some embodiments of the invention, the user need not be within the vicinity of the device, or item that they want unlocked, opened or manipulated. In some embodiments of the invention, the portable computing device may interact with the device, or item to be unlocked, opened or manipulated via cellular technology, radio signals, infrared, wireless or wired transmission, or other methods of sending a signal from the portable computing device to the device, or item to be unlocked, opened or manipulated.

In some embodiments of the invention, the user may open a software application 110 on their portable computing device and/or select from a group of selectable items which device, or item they want unlocked, opened or manipulated.

A user may select one item, in some embodiments, a user may select one or a plurality of items, in some embodiments, the user may select an order or a temporal pattern of devices or item that they want unlocked, opened or manipulated.

The user may view a screen, corresponding to the field of view of a camera coupled to portable computing device 10. The screen may have superimposed over the view of the camera, a plurality of shapes or images. The screen may include unmarked pre-designated zones. This portion of a method for use in an authentication protocol is depicted by box 120.

When prompted, the user may manipulate portable computing device 10, or one or a plurality of cameras coupled to portable device 10, such that a personal item, as viewed by the camera, e.g., within the camera's field of view, is partially or wholly within the shape, or in one of the pre-designated zones, as depicted by box 130.

In some embodiments of the invention, the user may need to inform the portable computing device that the personal item is within shape, for example, by interfacing with the screen or a button coupled to the portable computing device.

In some embodiments, the portable computing device, or a component thereof determines automatically or semi-automatically that the personal item is within the shape overlaid and/or superimposed on the screen, or within the pre-designated zone. In some embodiments, once a personal item has been aligned within a shape or a pre-designated zone, the user may indicate to software or the portable computing device that the personal item is aligned.

Box 140 represents a portion of the method wherein a user makes a first alignment of the personal item and in a shape or a pre-designated zone. The user may be prompted to do so by portable computing device 10.

Box 150 represents a portion of the method wherein a user makes subsequent alignments of the personal item and one or a plurality of shapes and/or pre-designated zones. If subsequent alignments conform to a predefined sequence pattern and/or temporal restrictions, then the portable computing device may signal to another device to perform an authentication-requiring action.

In some embodiments, the portable computing device or a component thereof, e.g., a processing unit, may be configured to validate the user's inputs and to determine if the inputted and/or aligned personal alignments conform to a predetermined authentication protocol, e.g., a predefined pattern. The processing unit may be coupled to the portable computing device, or may be located in a remote location.

If the first and subsequent alignments, e.g., the aligned images, conform to a predefined sequence pattern and/or temporal restriction, e.g., the authentication protocol, the portable computing device may validate the user's inputs and provide the now authenticated user with one or a plurality of control options to unlock, open, send a command to perform an authentication-requiring action and/or otherwise manipulate those one or a plurality of devices or items, including the option to deploy a key. This portion of the aforementioned method depicted as box 160.

In some embodiments, the one or a plurality of control options to facilitate access, unlock, open and/or otherwise manipulate those one or a plurality of devices or items may be limited to a specific place or temporal period subsequent to the first and subsequent alignments that conform to a predefined sequence pattern and/or temporal restrictions.

In some embodiments of the invention, if the first and subsequent alignments fail to conform to a predefined sequence pattern and/or temporal restriction, the user may be prompted to retry the alignments of the personal item and the shapes and/or pre-designated zones.

In some embodiments the user may be provided with a limited number of chances to successfully align the personal item with the shapes. In some embodiments of the invention, if the user fails to successfully align the personal item with the shapes a predetermined number of times, the portable computing device may send an email, SMS, text message, voice recording and/or other type of message to the user noting the failure to successfully align the personal item with the shapes. In some embodiments, if the user fails to successfully align the personal item with the shapes and/or pre-designated zones, a given or a predetermined number of times, the portable computing device may prevent and/or limit the user from using the portable computing device to unlock, open, send a command to a device to perform an authentication-requiring action, and/or otherwise manipulate those one or a plurality of devices or items for a predetermined time period.

In some embodiments, portable computing device may provide user with a string or other code that may need to be entered manually, automatically, or semi automatically into the device or item to be accessed, unlocked, opened and/or otherwise manipulated, the string or code sent via a text message or other method, in response to the user providing a validated authentication protocol.

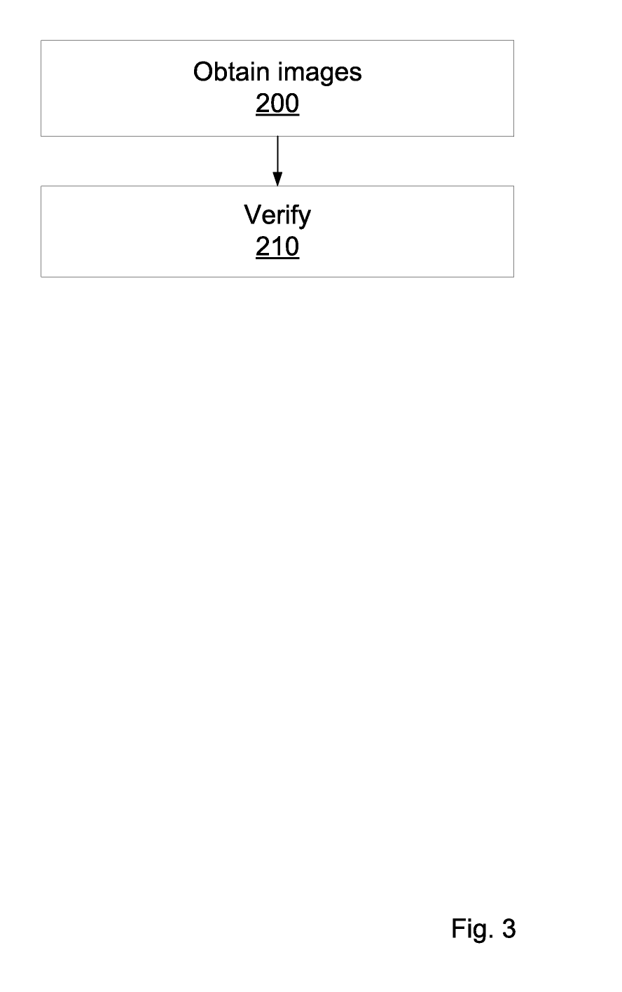

FIG. 3 is a schematic illustration of a method for method for a multi-tier authentication system according to an embodiment of the present invention.

A user may use the method to access a locked device, for example, a locked door. A user may be provided with a system whereby the door and the authentication system are provide pre-synced, e.g., the user does not have to input the particulars necessary for the handshake between the portable computing device and the door, wherein the handshake may include a transfer of data from the portable computing device to the door necessary for the door to complete the authentication-requiring action, e.g., to unlock and/or open.

A personal item, for example a fingerprint or a unique physical token may be registered by a system. The system may be associated with the portable computing device, may be a system on the portable computing device or may be a remote system, the remote system may be in communication with the portable computing device, or may not be in communication with the portable computing device.

The registration of a personal item may include verifying the nature of the item and may include creating a comprehensive file of the item such that it can be compared with an item that may be the registered personal item.

In some embodiments of the invention, a portable computing device may be configured to obtain at least one of a series of images of a registered personal item using an image sensor of a portable computing device, as depicted as box 200 in the figure.

The image sensor, for example, a camera on the portable computing device may capture a series of images; each of the images in the series may be used for a component in the authentication protocol.

In some embodiments, the image captured may be a video, a combination of a number of images optimized for the authentication method, and/or an audio/visual capture

The Authentication protocol may include requiring a user to manipulate the personal item, the portable computing device, or a component thereof, such that the personal item appear in at least one pre-designated zone on the screen of the device.

A local, or in some embodiments of the invention, a remote software program verifies that the registered personal item appears in a pre-designated zone within each image of said at least one of a series of images, such that the personal item appearance in the pre-designated zones follows a predetermined pattern, for example, the pattern required by the authentication protocol as depicted as box 210.

In some embodiments of the invention, a verification or validation of the personal item may include the use of software for comparing and analyzing images for authenticity. Authenticity may include confirming current possession of the personal item by the user inputting the personal item into the authentication protocol and to compare with known data regarding the personal items to validate that the image is an image of the personal item to be used in the authentication protocol.

If the user successfully uses images of the verified personal item within authentication protocol, the device is then configured to send a signal related to an authentication-requiring action, including opening, unlocking or otherwise manipulating a device. The authentication protocol may reside on software, the software may run on the cloud or on the portable computing device, e.g., within the processing unit.

In some embodiments the validation information may reside on the portable computing device. In some embodiments, the validation of the authentication protocol occurs remotely. In some embodiments, information for the validation of the authentication protocol may reside in the cloud or in another device. In some embodiments, the validation of the authentication protocol may be configurable by the user. In some embodiments, the validation of the authentication protocol may be device specific, e.g., if the portable computing device can control a plurality of devices, each device may have a distinct authentication protocol. In some embodiments, a user may have an authentication protocol for a plurality of devices.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for multi-tier authentication, the method comprising:
obtaining at least one of a series of images of a registered personal item using an image sensor of a portable computing device,
verifying that the registered personal item appears in a pre-designated zone within each image of said at least one of a series of images, such that the personal item appearance in the pre-designated zone follows a predetermined pattern.

2. The method of claim 1, wherein the pre-designated zones are shapes superimposed on a screen of a portable computing device.

3. The method of claim 1, further comprising verifying a second registered personal item.

4. The method of claim 1, wherein the portable computing device is a smartphone.

5. The method of claim 1, wherein the registered personal item is a fingerprint.

6. The method of claim 1 wherein a remote device is configured to verify that the registered personal item appears in a pre-designated zone within each image of said at least one of a series of images, such that the personal item appearance in the pre-designated zone follows a predetermined pattern.

7. The method of claim 1, further comprising causing a performance of an authentication-requiring action, after verifying that the registered personal item appears in the pre-designated zone within each image of said at least one of a series of images, such that the personal item appearance in the pre-designated zones follows the predetermined pattern.

8. The method of claim 7, wherein the authentication-requiring action is selected from the group consisting of opening, unlocking and manipulating devices remotely.

9. The method of claim 7, wherein an authentication-requiring action may be performed on a device, the device selected from the group consisting of a garage door, a car door, a window, a gate, a safe, a video game, accouterments of a garage door, a car door, a window, or a gate, a television, an entertainment unit, a computer, a recording device, a computing system, a smartphone, a weapon, a portable locking device, a bicycle lock, a drawer, a secret passage, a secret safe, a military device, a remote controlled car, a remote controlled device, secure room, a secure facility, a hotel room, a drone, a locker, an encrypted file, a virtual private network, a network access, a locker at a pickup location, a strongbox, and a vault.

10. A system for multi-tier authentication, the system comprising:
a portable computing device having an image sensor to obtain at least one of a series of images of a registered personal item, and
a processing unit to verify that the registered personal item appears in a pre-designated zone within each image of said at least one of a series of images, such that the personal item appearance in the pre-designated zones follows a predetermined pattern.

11. The system of claim 10, further comprising a communication unit to communicate a signal to perform an authentication-requiring action to a device, after verifying that the registered personal item appears in the pre-designated zone within each image of said at least one of a series of images, such that the personal item appearance in the pre-designated zones follows the predetermined pattern.

12. The system of claim 10 further comprising a device to perform an authentication-requiring action.

13. The system of claim 12 wherein the device to perform the authentication-requiring action is selected from the group consisting of a garage door, a car door, a window, a gate, a safe, a video game, accouterments of a garage door, a car door, a window, or a gate, a television, an entertainment unit, a computer, a recording device, a computing system, a smartphone, a weapon, a portable locking device, a bicycle lock, a drawer, a secret passage, a secret safe, a military device, a remote controlled car, a remote controlled device, secure room, a secure facility, a hotel room, a drone, a locker, an encrypted file, a virtual private network, a network access, a locker at a pickup location, a strongbox, and a vault.

14. The system of claim 10, wherein the portable computing device is a smartphone.

15. The system of claim 10, wherein the processing unit is in a remote location.

16. The system of claim 10, wherein the registered personal item is a fingerprint.

17. A non-transitory computer readable medium for multi-tier authentication, comprising instructions, which when executed cause one or a plurality of processors to:
obtain at least one of a series of images of a registered personal item using an image sensor of a portable computing device,
verify that the registered personal item appears in a pre-designated zone within each image of said at least one of a series of images, such that the personal item appearance in the pre-designated zone follows a predetermined pattern.

18. The non-transitory computer readable medium of claim 17, wherein the instructions are configured to be executed on a smartphone.

19. The non-transitory computer readable medium of claim 17, wherein some of the instructions are configured to be executed locally and some of the instructions are configured to be executed remotely.

20. The non-transitory computer readable medium of claim 17, further comprising instructions, which when executed cause one or a plurality of processors to perform an authentication-requiring action, after verifying that the registered personal item appears in the pre-designated zone within each image of said at least one of a series of images, such that the personal item appearance in the pre-designated zones follows the predetermined pattern.
